(19) United States
(12) Patent Application Publication
(10) Pub. No.: US 2011/0022301 A1
(43) Pub. Date: Jan. 27, 2011

(54) METHOD, MOBILE DEVICE AND RECORDING MEDIUM FOR RECORDING PARKING INFORMATION

(75) Inventor: Yu-Cheng Lee, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/843,872

(22) Filed: Jul. 26, 2010

Related U.S. Application Data
(60) Provisional application No. 61/228,957, filed on Jul. 27, 2009.

(30) Foreign Application Priority Data
Jun. 21, 2010 (TW) 99120094

(51) Int. Cl. G01C 21/36; G01C 21/00

(52) U.S. Cl. 701/201; 701/208

(57) ABSTRACT

A method, a mobile device and a recording medium for recording parking information are provided. In the present method, a current location of the mobile device is detected, and a trigger signal is detected. A parking information page is generated when the trigger signal is detected, wherein the parking information page comprises a parking image generated according to an electronic map of the current location of the mobile device and a parking location generated according to the current location of the mobile device.

This application claims the priority benefits of U.S. provisional application Ser. No. 61/228,957, filed on Jul. 27, 2009 and Taiwan patent application serial no. 99120094, filed on Jun. 21, 2010. The entirety of each of the above-mentioned patent applications is hereby incorporated by reference herein and made a part of specification.

### BACKGROUND OF THE INVENTION

A conventional navigation device has a built-in smart electronic map and offers a route planning and navigation function. When a destination is input into the navigation device by a user, the navigation device plans a navigation route and guides the user to travel towards the destination according to the navigation route with voice messages.

When the user reaches the destination by car, he/she has to look for a parking lot to park the car if there is no parking lot at the destination. Besides, when the user parks the car, he/she needs to memorize where the parking lot and the parking space are in order to find the car later on.

However, when the user returns from the destination to the parking lot to get the car, he/she has to find the parking lot or the parking space based on his/her memory. In this case, the user may not be able to find his/her way to the parking lot or the parking space if the parking lot is far from the destination or is too large. Thereby, a technique for conveniently recording parking information and guiding the user to find the car is desired.

### SUMMARY

Accordingly, the present application is directed to a method for recording parking information, wherein the parking information is recorded and used for guiding a user to find his car.

The present application is directed to a mobile device for recording a parking location, a map, or other information as a page, which can be viewed by a user conveniently.

The present application provides a parking information recording method adapted to a mobile device. In the present method, a current location of the mobile device is detected, and a trigger signal is detected. A parking information page is generated when the trigger signal is detected, wherein the parking information page comprises a parking image generated according to an electronic map of the current location of the mobile device and a parking location generated according to the current location of the mobile device.

In one example, after the step of detecting the current location of the mobile device, the method further comprises planning a first navigation route to a first parking lot around a destination according to the current location of the mobile device and displaying an electronic map comprising the first navigation route to execute a navigation function.

In one example, the step of planning the first navigation route to the first parking lot around the destination further comprises setting a prompt range and switching the electronic map from a 3-dimensional (3D) display mode to a 2-dimensional (2D) display mode when the mobile device enters the prompt range of the first parking lot.

In one example, after the step of setting the prompt range, the method further comprises determining whether the mobile device enters the prompt range of the first parking lot according to the current location of the mobile device, and detecting whether the first parking lot has an empty parking space when the mobile device enters the prompt range of the first parking lot, wherein if the first parking lot has no empty parking space, a second navigation route to a second parking lot around the destination is planned, and an electronic map comprising the second navigation route is displayed to execute the navigation function.

In one example, when the navigation function is executed, the method further comprises receiving a selection operation performed by a user on a third parking lot in the electronic map, planning a third navigation route to the third parking lot, and displaying an electronic map comprising the third navigation route to execute the navigation function.

In one example, the trigger signal may be triggered when the mobile device stops in the first parking lot.

In one example, the trigger signal may be triggered when the mobile device is removed from a device stand.

In one example, the trigger signal may be triggered when a triggering operation performed by the user is received.

In one example, when the trigger signal is detected, the method further comprises planning a fourth navigation route to walk to the destination according to the current location of the mobile device and displaying an electronic map comprising the fourth navigation route to execute the navigation function.

In one example, the step of generating the parking information page comprises generating the parking image of the parking information page according to the electronic map comprising the fourth navigation route that is currently displayed by the mobile device.

In one example, the step of generating the parking information page further comprises starting an image capturing unit of the mobile device, wherein the image capturing unit captures a plurality of images around the parking area in the parking lot and serves these images as other parking images of the parking information page.

In one example, the step of generating the parking information page further comprises receiving a string input by the user and serving the string as a parking annotation of the parking information page.

In one example, the parking information page comprises the parking time, the parking duration, the parking rate, the parking fee, the name of the parking location, or the latitude and longitude of the parking location.

In one example, after the step of generating the parking information page, the method further comprises receiving an operation performed by the user on the parking information page, planning a fifth navigation route to the parking location in the parking information page according to the current location of the mobile device, and displaying an electronic map comprising the fifth navigation route to execute the navigation function.

The present application provides a mobile device for recording parking information. The mobile device comprises a positioning unit, a display unit, a storage unit, and a processing unit. The positioning unit detects a current location of the mobile device. The processing unit is coupled to the positioning unit, the display unit, and the storage unit for generating a parking information page when a trigger signal is detected and recording the parking information page into the storage unit, wherein the parking information page comprising a parking image generated by the processing unit according to an electronic map of the current location of the mobile device and a parking location generated according to the detected current location of the mobile device.

The present application further provides a recording medium which records a computer program to be loaded into a mobile device to execute a parking information recording method which comprises following steps. First, a current location of the mobile device is detected, and a trigger signal is detected. A parking information page is generated when the trigger signal is detected, wherein the parking information page comprises a parking image generated according to an electronic map of the current location of the mobile device and a parking location generated according to the current location of the mobile device.

As described above, the present application provides a method, a mobile device, and a recording medium for recording parking information, wherein when a user drives into a parking lot and parks the car, the parking information (for example, the coordinates of the parking location and an electronic map) is recorded as a page, so that when the user returns to get the car, he/she can view the parking information in the parking information page and find the parking lot and parking space conveniently.

### BRIEF DESCRIPTION OF THE DRAWINGS

The accompanying drawings are included to provide a further understanding of the application, and are incorporated in and constitute a part of this specification. The drawings illustrate examples of the application and, together with the description, serve to explain the principles of the application.

FIG. 1 is a block diagram of a mobile device according to an example of the present application.

FIG. 2 is a flowchart of a parking information recording method according to a first example of the present application.

FIGS. 3A-3C illustrate an example of a parking information page according to the first example of the present application.

FIG. 4 is a flowchart of a parking information recording method according to a second example of the present application.

FIG. 5 is a flowchart of a parking information recording method according to a third example of the present application.

FIG. 6 is a flowchart of a parking information recording method according to a fourth example of the present application.

FIG. 7 illustrates an example of a parking information page according to the fourth example of the present application.

### DESCRIPTION OF THE EXAMPLES

Reference will now be made in detail to the present examples of the application, examples of which are illustrated in the accompanying drawings. Wherever possible, the same reference numbers are used in the drawings and the description to refer to the same or like parts.

In the present application, a navigation route is planed by setting a parking lot around a destination as an intermediate point, so as to guide a user to drive towards the parking lot. After the user parks his car, a walking route from the parking lot to the destination is automatically planned, so as to guide the user to walk towards the destination. When the user drives into the parking lot or parks the car in the parking lot, the parking information (for example, the coordinates and electronic map of the parking location) is displayed or recorded as a page in a mobile device, such that the user can be guided to the parking lot or the parking space conveniently when the user is about to get the car.

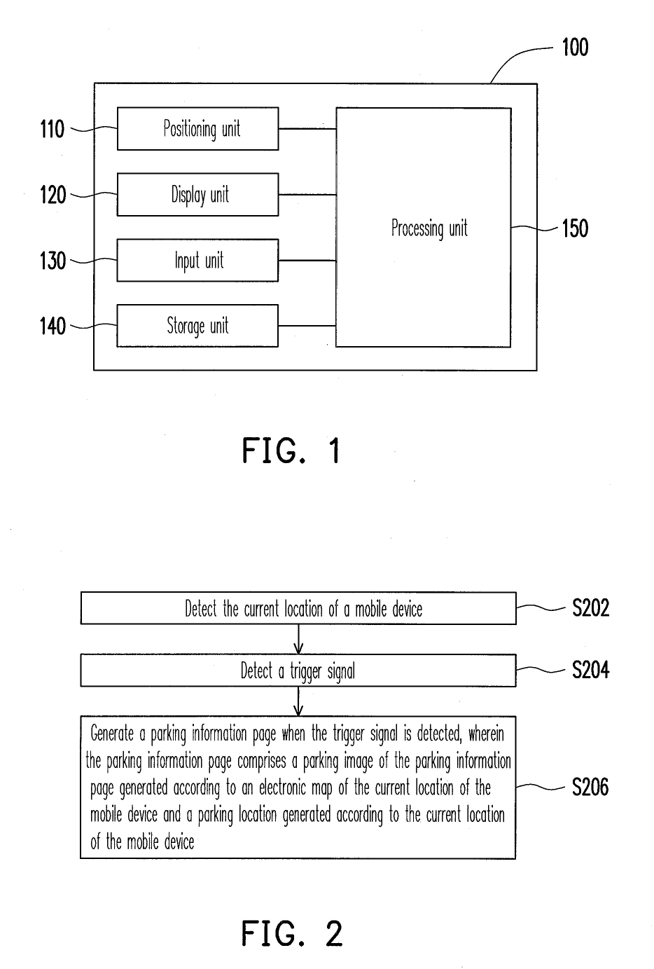

FIG. 1 is a block diagram of a mobile device according to an example of the present application. Referring to FIG. 1, the mobile device 100 may be a mobile phone, a Car PC, or a notebook computer with a positioning function, and which comprises a positioning unit 110, a display unit 120, an input unit 130, a storage unit 140, and a processing unit 150. The functions of these components are respectively described below.

The positioning unit 110 is used for obtaining the current location of the mobile device 100. The positioning unit 110 may be a global positioning system (GPS) or any other communication/positioning system that adopts the global system for mobile communication (GSM) system, the personal handy-phone system (PHS), the code division multiple access (CDMA) system, the wireless fidelity (Wi-Fi) system, the worldwide interoperability for microwave access (WiMAX) system, a radio repeater, or a radio broadcaster to perform the positioning function. However, the present application is not limited thereto.

The display unit 120 may be a liquid crystal display (LCD), a light-emitting diode (LED) display, a field emission display (FED), or other types of display.

The input unit 130 may be an input device, such as a mouse, a keyboard, a joystick, or a touch pad, for receiving user operations. Herein the input unit 130 may be a resistive touch sensor, a capacitive touch sensor, or other types of touch sensor, and which may be integrated with the display unit 120 into a touch screen.

The storage unit 140 may be any type of immovable or removable random access memory (RAM), read-only memory (ROM), flash memory, hard disc, remote memory that may be accessed remotely through a wireless network, or other similar devices, or a combination of these devices. The storage unit 140 is used for storing parking information or other information.

The processing unit 150 may be a central processing unit (CPU), a microprocessor, a digital signal processor (DSP), a programmable controller, an application specific integrated circuit (ASIC), a programmable logic device (PLD), or other similar devices, or a combination of foregoing devices.

The processing unit 150 is coupled to the positioning unit 110, the display unit 120, the input unit 130, and the storage unit 140. The processing unit 150 may generate a parking information page comprising parking information (for example, a parking image and a parking location) according to a trigger signal input by the input unit 130 or other means, such that a user can return to get the car conveniently. Below, the parking information recording method of the present application is described in detail with reference to examples of the present application.

### First Example

FIG. 2 is a flowchart of a parking information recording method according to the first example of the present application. Referring to FIG. 2, the method is adapted to the mobile device 100 illustrated in FIG. 1.

First, the positioning unit 110 detects the current location of the mobile device 100 (step S202). In an example, the processing unit 150 indicates the location of the mobile device 100 in an electronic map but the mobile device 100 executes no navigation function. In another example, the mobile device 100 executes the navigation function, in which the processing unit 150 plans a navigation route to a parking lot around a destination selected by the user and executes the navigation function to guide the user to drive towards the parking lot.

Then, the processing unit 150 detects a trigger signal (step S204). In an example, the mobile device 100 is disposed on a device stand (for example, a car holder) and connected to the device stand through a sensing component, and whether the mobile device 100 is removed from the device stand is determined through this sensing component. For example, the mobile device 100 is electrically connected to the device stand through specific pins, and whether the mobile device 100 is removed from the device stand is determined by detecting whether the pins are electrified. Alternatively, a hardware button may be disposed on the mobile device 100 for detecting a pressing operation performed by the user, and the trigger signal is triggered when the hardware button on the mobile device 100 is pressed by the user.

When the trigger signal is detected, the processing unit 150 automatically generates a parking information page. To be specific, the processing unit 150 generates a parking image of the parking information page according to the electronic map of the current location of the mobile device 100, and the processing unit 150 generates a parking location according to the current location (for example, the latitude and longitude, the address, the description of the location, such as the name of the intersection or the name of the building) of the mobile device 100 (step S206).

The parking information page is stored in the storage unit 140 so that it can be viewed by the user any time. Accordingly, the user is able to find the parking location conveniently based on the parking information page, and does not need to worry about that he/she cannot find the parking lot or the parking space or forget where the parking lot or the parking space is.

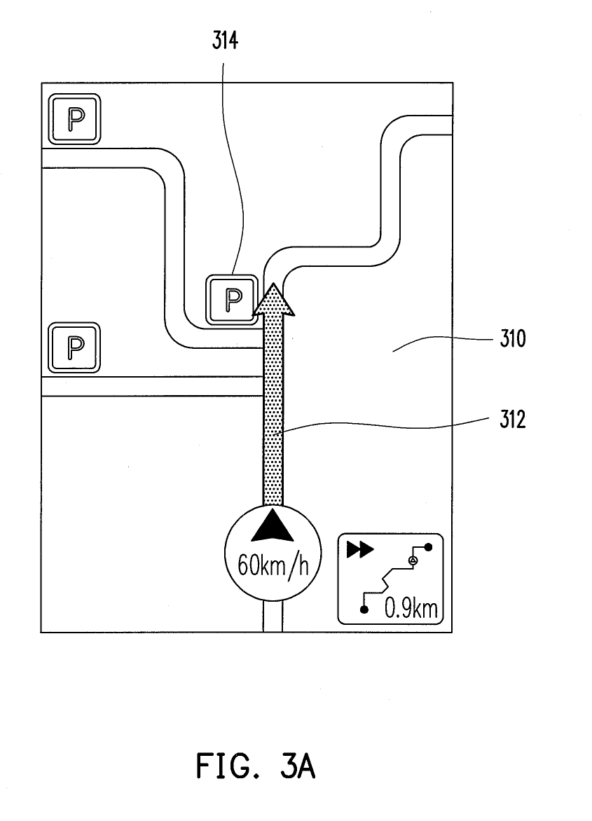

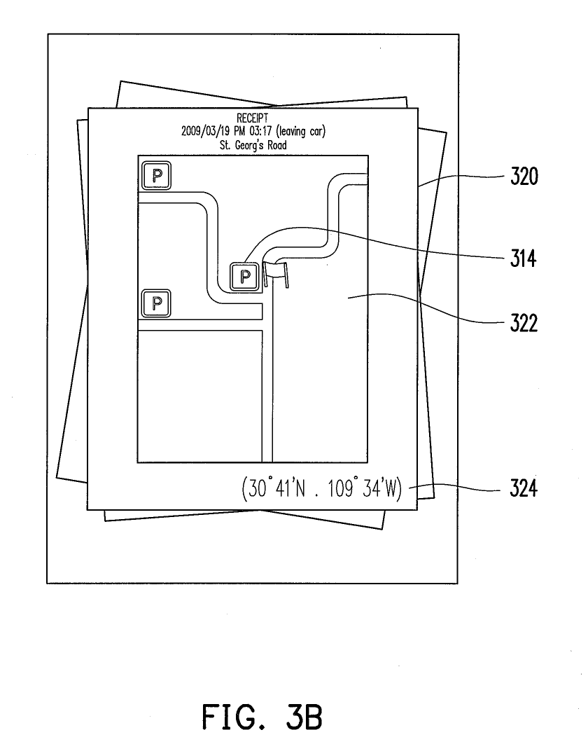

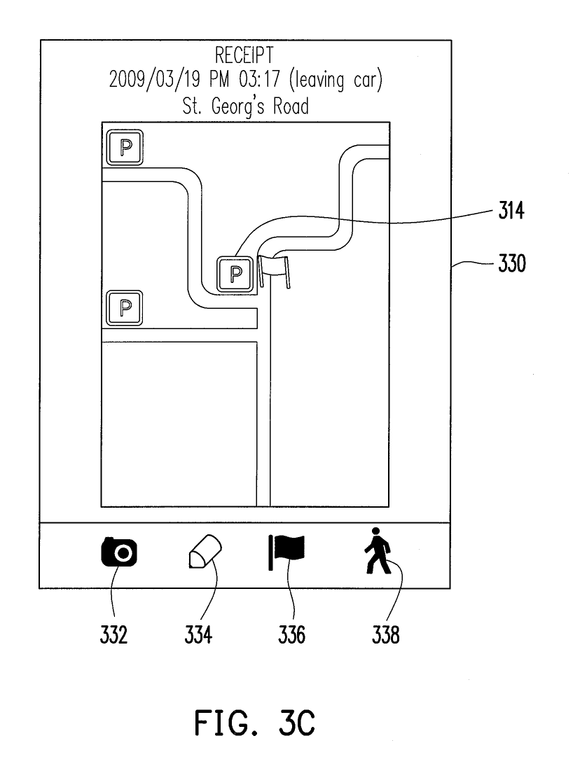

It should be noted that besides the parking image and the parking information, a plurality of function buttons may be further disposed in the parking information page such that the user may edit information in the parking information page or perform advanced functions. FIGS. 3A-3C illustrate an example of a parking information page according to the first example of the present application. Referring to FIG. 3A, a navigation image 310 is displayed on the screen of the mobile device, and a navigation route 312 is marked in the navigation image 310 for guiding the user to drive towards the parking lot 314. When the user reaches the parking lot 314 and parks the car and the trigger signal is triggered, the mobile device automatically generates the parking information page 320 as shown in FIG. 3B. To be specific, the mobile device generates a parking image 322 of the parking information page 320 according to an electronic map of the current location of the mobile device, and the mobile device detects the current location and serves it as the parking location 324 in the parking information page 320.

Herein if the user clicks on the parking information page 320 as illustrated in FIG. 3B, the mobile device enlarges the parking information page 320 into a parking information page 330 (as illustrated in FIG. 3C) and displays a camera button 332, a note button 334, a destination button 336, and a walking navigation button 338 at the lower portion of the parking information page 330. If the user presses the camera button 332, the mobile device activates its own camera so that the user can capture images around the parking area in the parking lot. These images may be used as other parking images in the parking information page 330 or used to replace the original parking image 322. Namely, the parking information page 330 may contain a plurality of parking image sheets for recording images related to the parking location (for example, the number of the parking space, the sign of the parking area, and the sign of the parking level) such that the user can find the parking space easily. If the user presses the note button 334, the mobile device opens a text editor, receives a string input by the user, and sets the string as a parking annotation in the parking information page 330. If the user presses the destination button 336, the mobile device denotes the destination with a mark (for example, a flag) in the parking information page 330, and the user may drag the mark to change the location of the destination. If the user presses the walking navigation button 338, the mobile device plans a walking route from the parking lot 314 to the destination and indicates it in the parking information page 330 to execute the navigation function.

Through the method described above, the mobile device 100 in the present example may integrate the parking time, the parking duration, the parking rate, the parking fee, the name of the parking location, and the latitude and longitude of the parking location into a parking information page so that a user can find the parking location conveniently by referring to the parking information page.

### Second Example

Besides generating the trigger signal through hardware detection and generating the parking information page according to a parking location and a parking image, a technique of generating the trigger signal through software detection is also provided in the present application.

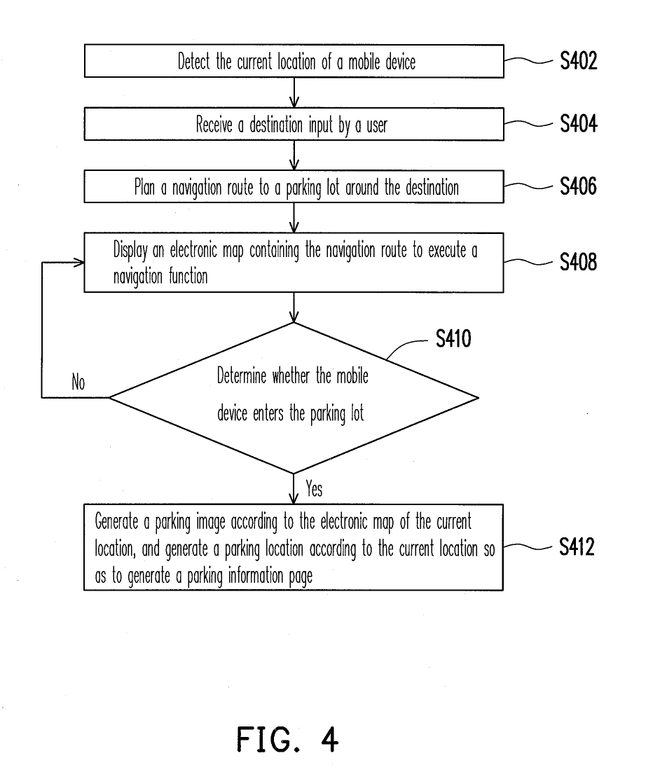

FIG. 4 is a flowchart of a parking information recording method according to the second example of the present application. Referring to FIG. 4, the method is adapted to the mobile device 100 illustrated in FIG. 1.

First, the positioning unit 110 detects the current location of the mobile device 100 (step S402) and receives a destination input by a user from the input unit 130 (step S404). Herein the user may input the name of the destination through the input unit 130 or select the destination from a menu displayed on the mobile device 100. However, the present application is not limited thereto.

Then, the processing unit 150 plans a navigation route to a parking lot around the destination according to the location detected by the positioning unit 110 and the destination received by the input unit 130 (step S406), and the processing unit 150 then displays an electronic map containing the navigation route in the display unit 120 to execute a navigation function (step S408).

When the navigation function is executed, the processing unit 150 determines whether the mobile device 100 enters the parking lot according to the location of the mobile device 100 (step S410). If the mobile device 100 enters the parking lot, the processing unit 150 generates a parking image according to the electronic map of the current location and a parking location according to the current location of the mobile device 100, so as to generate a parking information page (step S412). Otherwise, the mobile device 100 continues to execute the navigation function (step S408). In another example, the processing unit 150 determines whether to generate the parking information page according to whether the mobile device 100 stops in the parking lot (i.e., whether the car is parked). Herein a sensing unit on the mobile device 100 may be used for detecting whether the car is stopped so as to determine whether the car is parked. For example, whether the car is parked may be determined by using an acceleration sensor or by determining whether the images taken by the mobile device 100 have stopped changing. However, the present application is not limited thereto.

Through the method described above, the mobile device 100 is able to automatically capture parking information, for example parking images and coordinates, according to the relative position between the mobile device and the parking lot and generate a parking information page to be viewed by the user.

### Third Example

When a user is approaching or reaches a parking lot, he/she may change his/her mind and decide to go to another parking lot close by if the parking lot is full, the parking rate is high, or the traffic is heavy. In this case, the mobile device needs to provide a new route to guide the user to drive towards the next parking lot.

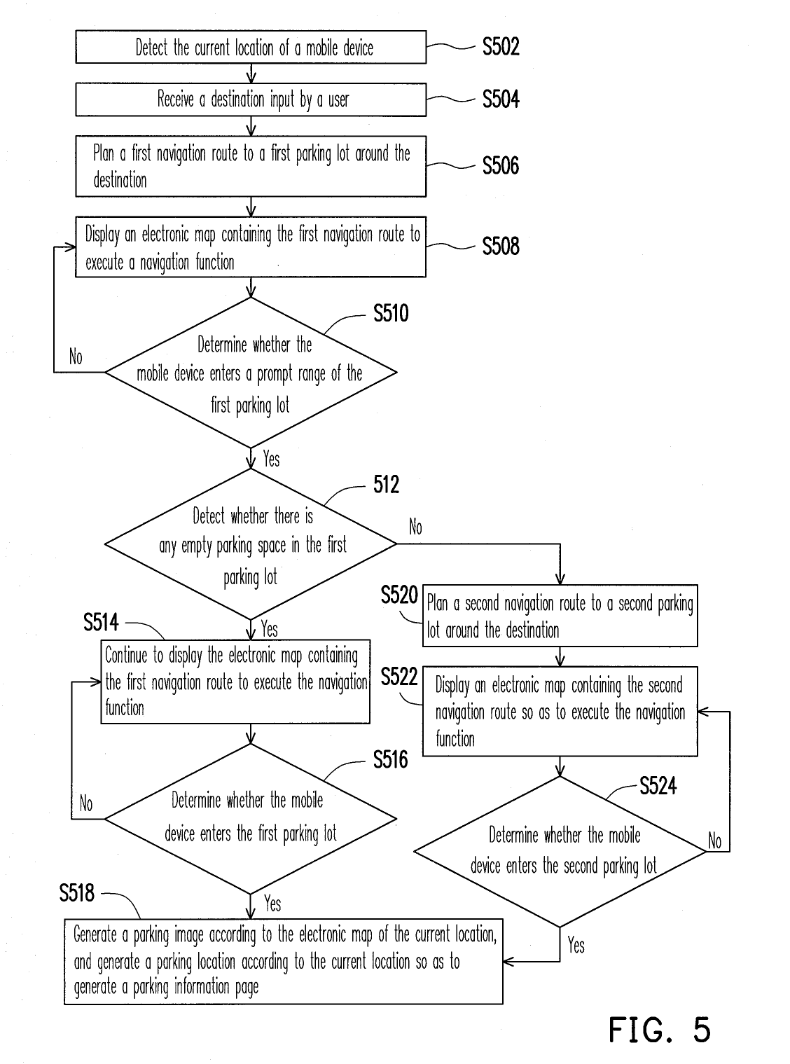

FIG. 5 is a flowchart of a parking information recording method according to the third example of the present application. Referring to FIG. 5, the method is adapted to the mobile device 100 illustrated in FIG. 1.

First, the positioning unit 110 detects the location of the mobile device 100 (step S502) and receives a destination input by a user from the input unit 130 (step S504).

Then, the processing unit 150 plans a first navigation route to a first parking lot around the destination according to the location detected by the positioning unit 110 and the destination received from the input unit 130 (step S506), and the processing unit 150 then displays an electronic map containing the first navigation route in the display unit 120 to execute the navigation function (step S508). When the user inputs the destination to plan the navigation route, the mobile device 100 may automatically set a prompt range or request the user to input the prompt range. Accordingly, when the mobile device 100 enters the prompt range of the first parking lot, whether there is any empty parking space in the first parking lot is first detected to inform the user so that the user can make decision accordingly. The prompt range may be a range within a radius of 300 meters or other ranges, which is not limited thereto.

When executing the navigation function, the processing unit 150 determines whether the mobile device 100 enters the prompt range of the first parking lot (step S510). Before the mobile device 100 enters the prompt range of the first parking lot, the processing unit 150 continues to execute the navigation function (step S508). Contrarily, when the mobile device 100 enters the prompt range of the first parking lot, the processing unit 150 further detects whether there is any empty parking space in the first parking lot (step S512) to inform the user so that the user can make decision accordingly. In another example, when the mobile device 100 enters the prompt range of the first parking lot, the processing unit 150 switches the displayed electronic map from a 3-dimensional (3D) display mode to a 2-dimensional (2D) display mode so that the user can see the details of the navigation route clearly.

If there is an empty parking space in the first parking lot, the processing unit 150 continues to display the electronic map containing the first navigation route so as to execute the navigation function (step S514), and the processing unit 150 determines whether the mobile device 100 has entered the first parking lot (step S516). When the mobile device 100 enters the first parking lot, the processing unit 150 generates a parking image according to the electronic map of the current location and generates a parking location according to the current location, so as to generate a parking information page (step S518). Otherwise, when the mobile device 100 has not entered the first parking lot, the mobile device 100 continues to execute the navigation function (step S514).

Contrarily, if there is no empty parking space in the first parking lot, the processing unit 150 plans a second navigation route to a second parking lot around the destination (step S520) and displays an electronic map containing the second navigation route in the display unit 120 to execute the navigation function (step S522). The processing unit 150 also determines whether the mobile device 100 enters the second parking lot while executing the navigation function (step S524). When the mobile device 100 enters the second parking lot, the processing unit 150 generates a parking image according to the electronic map of the current location and generates a parking location according to the current location, so as to generate a parking information page (step S518). Otherwise, when the mobile device 100 has not entered the second parking lot, the mobile device 100 continues to execute the navigation function (step S522).

Through the method described above, the mobile device 100 captures and displays empty space information of a parking lot in advance so that the user can respond accordingly and find a parking lot with available parking spaces conveniently.

It should be noted that when the mobile device 100 executes the navigation function, it may also receive a selection operation performed by the user on another parking lot in the electronic map, so as to plan a navigation route to this parking lot and display an electronic map containing this navigation route to execute the navigation function.

### Fourth Example

Because the parking lot may be at a distance away from the destination, the mobile device of the present application further plans a navigation route for guiding the user to walk from the parking lot to the destination after the user parks the car. This navigation route may be captured and stored in the mobile device in advance so that the user can view it any time.

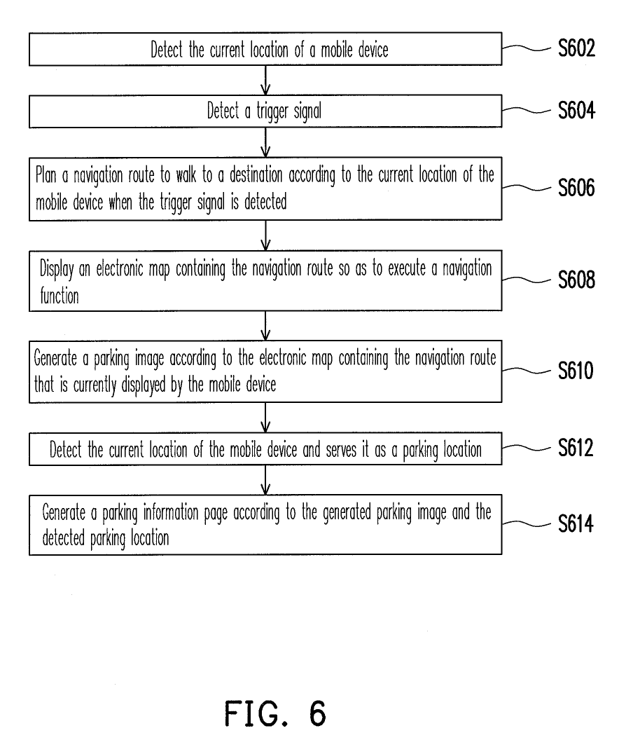

FIG. 6 is a flowchart of a parking information recording method according to the fourth example of the present application. Referring to FIG. 6, the method is adapted to the mobile device 100 illustrated in FIG. 1.

First, the positioning unit 110 detects the location of the mobile device 100 (step S602). To be specific, the processing unit 150 plans a navigation route from the current location to a parking lot around a destination according to the destination input by the user and executes a navigation function to guide the user to drive towards the parking lot.

Then, the mobile device 100 detects a trigger signal (step S604). Herein the mobile device 100 may detect the trigger signal through hardware detection or software detection, and the detailed implementation of which has been described in foregoing examples therefore will not be described herein.

When the trigger signal is detected, the mobile device 100 plans a navigation route to walk to the destination according to its current location (step S606) and displays an electronic map containing the navigation route in the display unit 140 so as to execute a navigation function (step S608).

It should be noted that when the mobile device 100 displays the electronic map, it further generates a parking image according to the currently displayed electronic map containing the navigation route (step S610). The mobile device 100 detects the current location of the mobile device 100 and serves it as a parking location (step S612), so as to generate a parking information page (step S614). The parking information page may be stored in the storage unit 140 to be viewed by the user any time. The user can get to know about the walking route between the parking lot and the destination according to the parking information page and return to the parking lot to get the car accordingly.

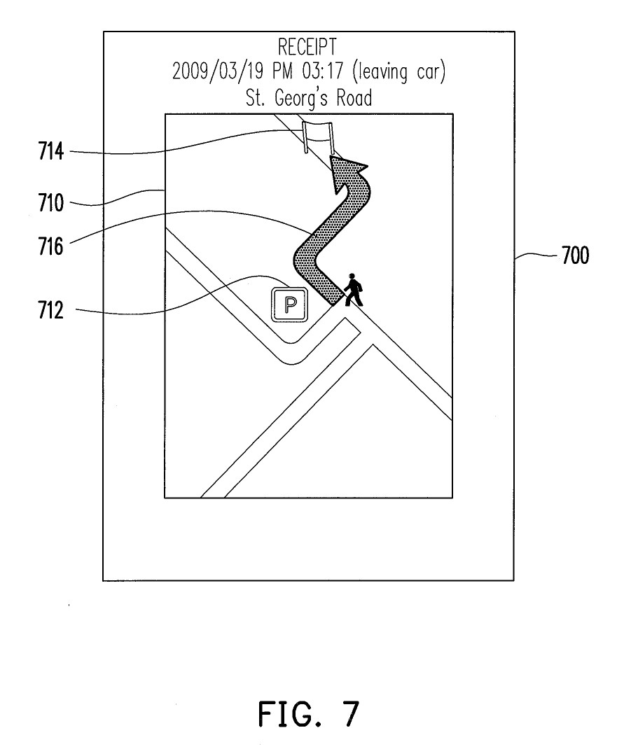

FIG. 7 illustrates an example of a parking information page according to the fourth example of the present application. Referring to FIG. 7, the parking information page 700 records an electronic map 710 containing a navigation route 716 from the parking lot 712 to the destination 714. A user can know the route to the destination 714 according to the parking information page 700. When the user is about to return to the parking lot 712 from the destination 714 to get the car, he/she can also know the route to return to the parking lot 712 according to the parking information page 700 so that the user won't get lost.

In another example, when the user is about to return from the destination to the parking lot to get the car, he/she may also request the mobile device 100 to execute the navigation function by clicking at the parking information page, so as to be guided back to the parking lot. To be specific, the mobile device 100 receives a selection operation performed by the user on the parking information page through the input unit 130, and then the processing unit 150 plans a navigation route to the parking location in the parking information page according to the current location of the mobile device 100 and displays an electronic map containing the navigation route on the display unit 140, so as to execute the navigation function.

The present application also provides a recording medium which records a computer program to be loaded into a mobile device to execute the parking information recording method described above. The computer program is composed of a plurality of program instructions (for example, an organization chart establishing program instruction, a table approving program instruction, a setting program instruction, and a deployment program instruction, etc). These program instructions can be loaded into a mobile device and executed by the same to accomplish the parking information recording method and the functions of the mobile device described above.

In summary, the present application provides a method, a mobile device, and a recording medium for recording parking information, wherein parking information is recorded as a page, and when a user drives into a parking lot or parks his/her car, parking related information is automatically captured and recorded in the parking information page. Thus, when subsequently the user returns to the parking lot to get the car, he/she can conveniently find the parking lot and parking space according to the information in the parking information page.

It will be apparent to those skilled in the art that various modifications and variations can be made to the structure of the present application without departing from the scope or spirit of the application. In view of the foregoing, it is intended that the present application cover modifications and variations of this application provided they fall within the scope of the following claims and their equivalents.

What is claimed is:

1. A method for recording parking information, adapted to a mobile device, the method comprising:
detecting a current location of the mobile device;
detecting a trigger signal;
generating a parking information page when the trigger signal is detected, wherein the parking information page comprises a parking image generated according to an electronic map of the current location of the mobile device and a parking location generated according to the current location of the mobile device.

2. The method of claim 1, wherein after the step of detecting the current location of the mobile device, the method further comprises:
planning a first navigation route to a first parking lot around a destination according to the current location of the mobile device;
displaying an electronic map comprising the first navigation route to execute a navigation function; and
setting a prompt range, and switching the electronic map from a 3-dimensional (3D) display mode to a 2-dimensional (2D) display mode when the mobile device enters the prompt range of the first parking lot.

3. The method of claim 1, wherein the trigger signal is triggered when the mobile device enters or stops in a parking lot.

4. The method of claim 1, wherein the trigger signal is triggered when the mobile device is removed from a device stand.

5. The method of claim 1, wherein when the trigger signal is detected, the method further comprising:
planning a fourth navigation route to walk to the destination of the current location of the mobile device;
displaying an electronic map comprising the fourth navigation route; and
generating the parking image of the parking information page of the electronic map comprising the fourth navigation route.

6. The method of claim 1, wherein after the step of generating the parking information page, the method further comprises:
receiving an operation performed by the user on the parking information page;
planning a fifth navigation route to the parking location in the parking information page of the current location of the mobile device; and
displaying an electronic map comprising the fifth navigation route to execute a navigation function.

7. The method of claim 1, further comprising:
receiving a plurality of images and;
serving the received images as other parking images of the parking information page.

8. A recording medium, recording program instructions for:
detecting a current location of a mobile device;
detecting a trigger signal;
generating a parking information page when the trigger signal is detected, wherein the parking information page comprises a parking image generated according to an electronic map of the current location of the mobile device and a parking location generated according to the current location of the mobile device.

9. A mobile device for recording parking information, comprising:
a positioning unit, for detecting a current location of the mobile device;
a display unit, for displaying the parking information;
a storage unit, for storing the parking information; and
a processing unit, coupled to the positioning unit, the display unit, and the storage unit, for generating a parking information page when a trigger signal is detected and recording the parking information page into the storage unit, wherein parking information page comprising a parking image generated by the processing unit according to an electronic map of the current location of the mobile device and a parking location generated according to the detected current location of the mobile device.

10. The mobile device of claim 9, further comprising:
an input unit, coupled to the processing unit, for receiving operations input by a user,
wherein when the input unit receives a destination input by a user, the processing unit plans a first navigation route to a first parking lot around the destination according to the current location of the mobile device and displays an electronic map comprising the first navigation route in the display unit to execute a navigation function, and the processing unit further switches the electronic map from a 3D display mode to a 2D display mode when the mobile device enters a prompt range of the first parking lot.

11. The mobile device of claim 10, wherein the processing unit further determines whether the mobile device enters the prompt range of the first parking lot according to the current location of the mobile device, and the processing unit detects whether the first parking lot has an empty parking space when the mobile device enters the prompt range of the first parking lot, wherein if the first parking lot has no empty parking space, the processing unit plans a second navigation route to a second parking lot around the destination and displays an electronic map comprising the second navigation route in the display unit to execute the navigation function.

12. The mobile device of claim 10, wherein when the input unit receives a selection operation performed by the user on a third parking lot in the electronic map, the processing unit plans a third navigation route to the third parking lot and displays an electronic map comprising the third navigation route in the display unit to execute the navigation function.

13. The mobile device of claim 9, wherein the processing unit triggers the trigger signal when the mobile device enters in a parking lot.

14. The mobile device of claim 9, wherein the processing unit triggers the trigger signal when the mobile device stops in a parking lot.

15. The mobile device of claim 9, wherein the processing unit triggers the trigger signal when the mobile device is removed from a device stand.

16. The mobile device of claim 9, wherein the processing unit triggers the trigger signal when a triggering operation performed by a user is received.

17. The mobile device of claim 9, wherein when the input unit receives an operation performed by the user on the parking information page, the processing unit plans a fifth navigation route to the parking location in the parking information page according to a current location of the mobile device and displays an electronic map comprising the fifth navigation route in the display unit to execute the navigation function.

18. The mobile device of claim 9, wherein when the trigger signal is detected, the processing unit further plans a fourth navigation route to walk to the destination according to the current location of the mobile device, displays an electronic map comprising the fourth navigation route in the display unit, and generates the parking image of the parking information page according to the electronic map.

19. The mobile device of claim 9 further comprising:
an image capturing unit, for capturing an image, wherein when the trigger signal is detected, the image capturing unit receives a plurality of images and serves the images as other parking images of the parking information page.
